(19) United States
(12) Patent Application Publication
(10) Pub. No.: US 2008/0003089 A1
(43) Pub. Date: Jan. 3, 2008

(54) Vehicle

(76) Inventor: Ronan Mallaghan, Dungannon (IE)

Correspondence Address: OSTROLENK FABER GERB & SOFFEN, 1180 AVENUE OF THE AMERICAS, NEW YORK, NY, 100368403, US

(21) Appl. No.: 11/480,147

(22) Filed: Jun. 30, 2006

(51) Int. Cl. B60P 1/00

(52) U.S. Cl. 414/528

(57) ABSTRACT

A vehicle comprising carriage means for transporting the vehicle along the ground and conveyor means mounted on the carriage means for conveying at least one article along the conveyor means.

### FIELD OF THE INVENTION

The present invention relates to a vehicle and in particular to a towable baggage handling apparatus for assisting an operator during loading and unloading of baggage to and from an aeroplane.

### SUMMARY OF THE INVENTION

The present method of loading and unloading passenger baggage to and from aeroplanes involves the delivery of a towable baggage cart to a location adjacent the cargo storage area of an aeroplane by a powered vehicle. During unloading, a first operator stands at a first end of the baggage cart beside the open door of the cargo storage area of the aeroplane and lifts the luggage from the baggage storage area of the aeroplane onto the first end of the baggage cart. A second operator then lifts the luggage from the first end of the baggage cart and carries it to the second end of the baggage cart and begins to stack the luggage at the second end. This procedure continues until either all of the luggage has been removed from the storage area of the aeroplane or until the baggage cart is full. When the entire luggage has been removed from the storage area of the aeroplane or when the baggage cart is packed to capacity, the baggage cart is towed to a portal for a predetermined baggage reclamation carousel. The carousel extends from the portal inside the airport terminal and the baggage is loaded onto the carousel via the portal.

During loading of the luggage onto the aeroplane, the first operator passes the luggage from the cart into the cargo loading area of the aeroplane quite readily when the cart is full or almost full of baggage. However, when the operator has loaded over half of the luggage, continued loading requires the operator to travel along the cart to collect the luggage and to carry the luggage back towards the aeroplane. Alternatively, a second operator is required to pass the luggage from the other half of the cart to the first operator who must then load the baggage into the cargo storage area of the aeroplane.

While these methods are effective to achieve the desired result, they involve either the use of two operators resulting in increased costs for the airline operators or considerable manual labour for a single luggage handler who must both carry the luggage and load/unload the luggage. It is an object of the present invention to provide an apparatus to overcome the requirement for two operators to load and unload passenger luggage from a baggage cart to and from an aeroplane and to reduce the workload for the remaining single operator.

Accordingly, the present invention provides a vehicle comprising carriage means for transporting the vehicle along the ground and conveyor means mounted on the carriage means for conveying at least one article along the conveyor means.

Ideally, the conveyor means conveys the article away from or towards an operator who is loading or unloading the at least one article to or from the vehicle.

Preferably, the vehicle is a baggage handling apparatus.

Ideally, the baggage handling apparatus is towable.

Ideally, a plurality of articles are loadable or unloadable.

Preferably, the articles are items of luggage.

Advantageously, the conveyor means of the towable baggage handling apparatus allows a single operator to unload and stack a row of luggage on the conveyor means adjacent the point where the operator is standing. When the space on the conveyor means adjacent the operator is packed with bags the operator can manually operate the conveyor means to move the stacked luggage away from themselves providing new space for further luggage to be stacked upon.

Ideally, the conveyor means is movably mounted on the carriage means.

Preferably, the conveyor means is rotatably mounted on the carriage means.

Preferably, the conveyor means comprises a driver roller at one end of the conveyor means and a driven roller at the other end of the conveyor means and an endless conveyor belt wound around the driver roller and the driven roller.

Ideally, conveyor drive means are in operable engagement with the driver roller.

Preferably, the conveyor drive means is hydraulic.

Ideally, the conveyor drive means is a hydraulic motor.

Preferably, the conveyor means has an elongate support frame for retaining the driver roller and the driven roller at opposite ends thereof.

Ideally, the conveyor drive means is mounted on the elongate support frame.

Preferably, guard rails are provided along the lateral edges of the elongate support frame.

Ideally, the guard rails extend substantially orthogonally to the main plane of the elongate support frame, upright in use.

Ideally, the guard rails have panels fitted between gaps in the rails.

Advantageously, the guard rails and panels prevent luggage falling off the vehicle during towing, loading or unloading. Ideally, the panels are transparent.

Preferably, temporary fastening means are provided to extend across the open ends of the guard rails. Advantageously, these temporary fastening means such as ribbons/braces prevent luggage toppling off the ends of the conveyor belt during transportation.

Ideally, the carriage means comprises a chassis carried on wheel means.

Preferably, the chassis has an operator platform. Advantageously, the operator platform supports an operator during loading and unloading of the luggage to and from the aeroplane.

Ideally, the operator platform is below the upper surface of the conveyor belt.

Preferably, control means for the conveyor drive means are provided on the vehicle proximal to the operator platform.

Advantageously, the control means for the conveyor drive means are provided within easy reach of the operator while the operator is standing on the operator platform.

Ideally, the control means for the conveyor drive means are provided on the conveyor means proximal to the operator platform.

Preferably, the control means for the conveyor drive means are provided on the guard rail proximal to the operator platform.

Ideally, the control drive means for the conveyor drive means drive the conveyor belt in a clockwise and anticlockwise direction.

Ideally, the control means for the conveyor drive means comprises a number of electrical switches for driving the conveyor belt in a clockwise or an anticlockwise direction.

Preferably, the electrical switches are coupled to solenoids which are coupled to a hydraulic motor.

Ideally, the conveyor means is mounted on a turntable which is rotatably housed on the carriage means.

Preferably, locking means are provided for locking the conveyor means in a fixed angular position relative to the carriage means.

Ideally, the locking means are releasable manually.

Preferably, the conveyor means rotates freely under manual pressure such as the operator pushing the conveyor means when the locking means are released.

Ideally, the locking means are capable of locking the conveyor means in a number of angular positions relative to the carriage means.

Ideally, the wheel means comprises a pair of loading wheels mounted at mutually opposing locations at or about the end of the chassis carrying the operator platform and a pair of towing wheels mounted at mutually opposing locations at or about a towing end of the chassis.

Preferably, the wheel means comprises a pair of loading wheels separately mounted on a pair of loading wheel axles carried on a pair of wheel mounting assemblies, the wheel mounting assemblies being connected to the chassis at mutually opposing locations at or about the end of the chassis carrying the operator platform.

Ideally, the wheel means also comprises a towing turntable mounted on the towing end of the chassis and having a towing axle mounted there below, each end of the towing axle having a towing wheel mounted thereon.

Preferably, the towing axle extends from diametrically opposed locations of the towing turntable.

Ideally, a tow bar extends from the towing turntable and protrudes beyond the towing end of the chassis.

Preferably, the tow bar has a first substantially horizontal position and a second substantially vertical position and is manually adjustable between the two positions.

Ideally, the towing turntable is rotatably mounted on the chasis.

Preferably, the towing axle is fixedly mounted to the underside of the towing turntable.

Ideally, the towing turntable and the towing axle rotate simultaneously.

Advantageously, the towing vehicle is coupled to the vehicle via the tow bar. As the towing vehicle travels around a corner the tow bar rotates the towing turntable relative to the chassis and simultaneously rotates the towing axle by the same angle causing the towed vehicle to follow the direction of the towing vehicle.

Ideally, towing turntable fixing means are provided intermediate the towing turntable and the chassis.

Preferably, the towing turntable fixing means are operable by moving the tow bar between its first substantially horizontal position and its second substantially vertical position.

Ideally, the towing turntable fixing means fix the towing turntable relative to the chassis by moving the tow bar between its first substantially horizontal position and its second substantially vertical position.

Preferably, the towing turntable fixing means releases the towing turntable relative to the chassis by moving the tow bar between its second substantially vertical position and its first substantially horizontal position.

Ideally, a steering arrangement is operably coupled to the loading wheels.

Preferably, the steering arrangement is hydraulically operated.

Ideally, the steering arrangement comprises a single hydraulic ram.

Preferably, the single hydraulic ram acts on a steering rod coupled between the loading wheels.

Ideally, at least one wheel has drive means.

Preferably, a loading wheel has drive means. Ideally, the wheel drive means is powered by a hydraulic motor.

Ideally, a means for simultaneously controlling the wheel drive means and the steering control means is provided on the vehicle.

Preferably, a control unit is provided on the chassis for simultaneously controlling operation of the hydraulic ram of the steering arrangement and the hydraulic motor of the wheel drive means.

Ideally, the control unit is a joystick and box unit.

Advantageously, the combined wheel drive means and steering control means allows a single operator to deliver the vehicle accurately into position at the side of the aeroplane by allowing the operator to move the vehicle backwards and forwards while simultaneously steering the vehicle.

Advantageously, when the tow bar is in its first substantially horizontal position, the vehicle is towable and the towing turntable and towing axis provide steering assistance to the operator of the towing vehicle. When the towing vehicle has delivered the vehicle to the site for loading and unloading, an operator can raise the tow bar into its second substantially vertical position which fixes the towing turntable and towing axle relative to the chassis so that the longitudinal axis of the towing axle is perpendicular to the longitudinal axis of the chassis. At this point, the operator can operate the combined steering control means and wheel drive means to accurately locate the vehicle adjacent the loading/unloading area without the need of a towing vehicle.

In a second embodiment of vehicle, the conveyor means is vertically movable relative to the carriage means.

In the second embodiment, hydraulic rams are mounted intermediate the conveyor means and the carriage means.

In the second embodiment, two pairs of hydraulic rams are mounted on longitudinally spaced and mutually opposing locations along opposite lateral edges of the conveyor means and the carriage means.

In the second embodiment, stabilising means are mounted on the vehicle.

In the second embodiment, the stabilising means are provided by hydraulically actuated stabilising jacks.

In the second embodiment, two pairs of stabilising jacks are mounted on longitudinally spaced and mutually opposing locations along opposite lateral edges of the conveyor means and the carriage means.

The invention will now be described with reference to the accompanying drawings, which show by way of example only, two embodiments of vehicle in accordance with the invention. In the drawings:

### BRIEF DESCRIPTION OF THE DRAWINGS

FIG. 1 is an elevational view of a first embodiment of baggage handling apparatus;

FIG. 2 is a top plan view of the first embodiment of baggage handling apparatus;

FIG. 3 is a first end view of the first embodiment of baggage handling apparatus;

FIG. 4 is a second end view of the first embodiment of baggage handling apparatus;

FIG. 5 is an elevational view of a second embodiment of baggage handling apparatus;

FIG. 6 is an end view of the second embodiment of baggage handling apparatus; and

FIG. 7 is a top plan view of the second embodiment of baggage handling apparatus.

### DESCRIPTION OF PREFERRED EMBODIMENTS OF THE INVENTION

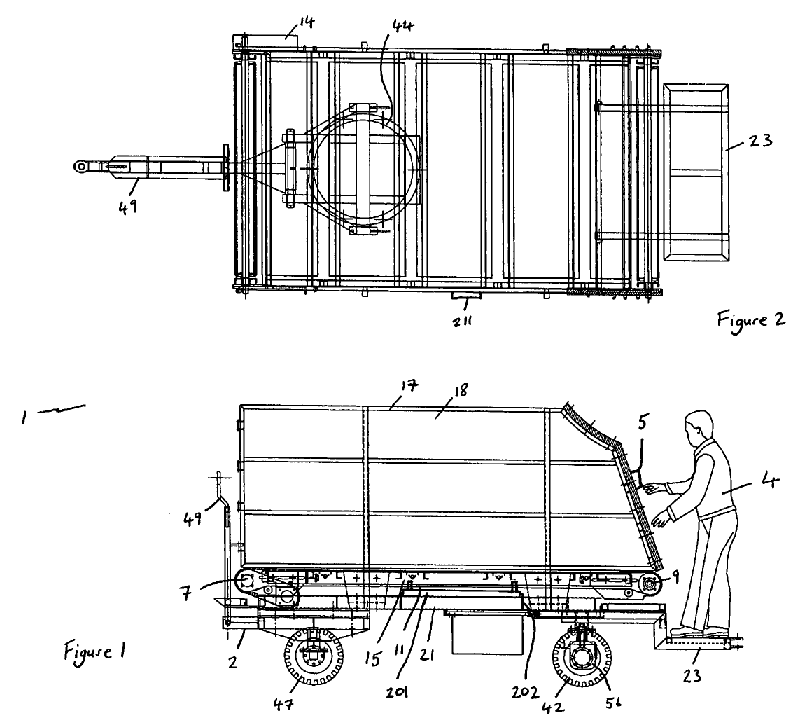

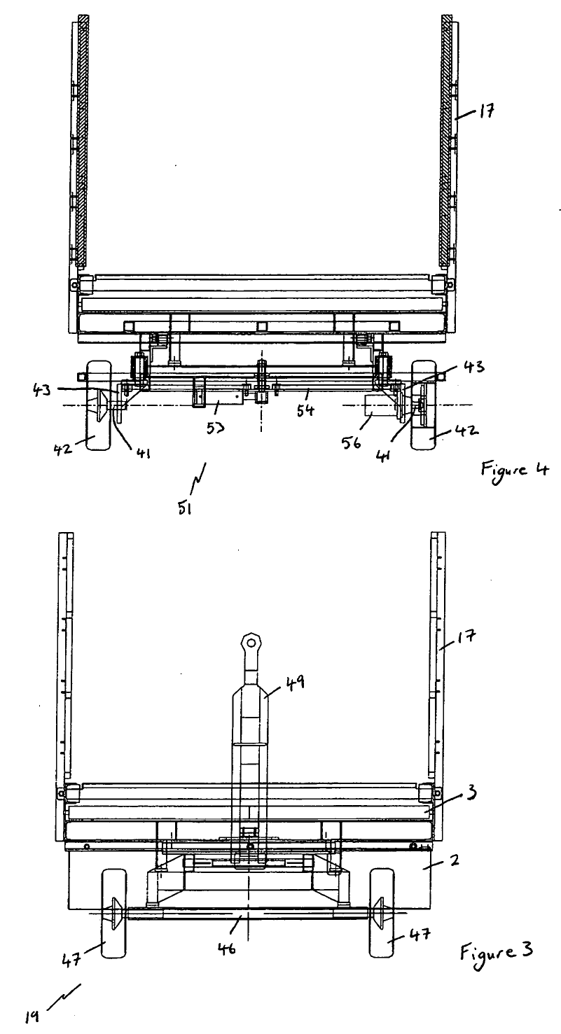

Referring to FIGS. 1 to 4 of the drawings, there is shown a first embodiment of a vehicle indicated generally by the reference numeral 1 having a carriage 2 for transporting the vehicle 1 along the ground and a conveyor arrangement 3 mounted on the carriage 2 for conveying articles (not shown) away from or towards an operator 4 who is loading or unloading the articles to or from the vehicle 1. The vehicle 1 is a baggage handling apparatus and the baggage handling apparatus is towable. The articles are generally items of luggage.

Advantageously, the conveyor arrangement 3 of the towable baggage handling apparatus allows a single operator 4 to unload and stack a row of luggage on the conveyor arrangement 3 adjacent the point where the operator 4 is standing. When the space on the conveyor arrangement 3 adjacent the operator 4 is packed with bags the operator 4 can manually operate the conveyor arrangement 3 to move the stacked luggage away from themselves providing new space for further luggage to be stacked upon.

The conveyor arrangement 3 is movably mounted on the carriage 2 and in this embodiment the conveyor arrangement 3 is rotatably mounted on the carriage 2. The conveyor arrangement 3 comprises a driver roller 7 at one end of the conveyor arrangement 3 and a driven roller 9 at the other end of the conveyor arrangement 3 and an endless conveyor belt 11 wound around the driver roller 7 and the driven roller 9. A conveyor drive 14 is in operable engagement with the driver roller 7 and the conveyor drive 14 is a hydraulic motor.

The conveyor arrangement 3 has an elongate support frame 15 for retaining the driver roller 7 and the driven roller 9 at opposite ends of the elongate support frame 15. The conveyor drive 14 is mounted on the elongate support frame 15. Guard rails 17 are provided along the lateral edges of the elongate support frame 15 and the guard rails 17 extend orthogonally to the main plane of the elongate support frame 15, upright in use. The guard rails 17 have panels 18 fitted between gaps in the rails 17.

Advantageously, the guard rails 17 and panels 18 prevent luggage falling off the vehicle 1 during towing, loading or unloading. Ideally, the panels 18 are transparent and are manufactured from a transparent sheet material such as Perspex®.

Temporary fastening members are provided to extend across the open ends of the guard rails 17. Advantageously, these temporary fastening means such as ribbons/braces prevent luggage toppling off the ends of the conveyor belt 11 during transportation.

The carriage 2 comprises a chassis 21 carried on a wheel arrangement indicated generally by the reference numeral 19. The chassis 21 has an operator platform 23 at one end. Advantageously, the operator platform 23 supports an operator 4 during loading and unloading of the luggage to and from an aeroplane, for example. It will of course be appreciated that although the present invention is described with reference in particular to a baggage handling apparatus for loading and unloading aeroplanes, the invention is equally useful as a trailer for any transport vehicle requiring manual loading and unloading.

The operator platform 23 is below the upper surface of the conveyor belt 11 at a vertical height off the ground in a range of between 360 mm and 400 mm. A particularly preferred height is 385 mm off the ground.

A control 5 for the conveyor drive 14 is provided on the vehicle 1 proximal to the operator platform 23. Advantageously, the control 5 for the conveyor drive 14 is provided within easy reach of the operator 4 while the operator 4 is standing on the operator platform 23. The control 5 for the conveyor drive 14 is provided on the guard rail 17 proximal to the operator platform 23. The control 5 for the conveyor drive 14 comprises a number of electrical switches for driving the conveyor belt 11 in a clockwise or an anticlockwise direction. The electrical switches are coupled to solenoids which are coupled to a hydraulic motor 14.

The conveyor arrangement 3 is mounted on a turntable 201 which is rotatably mounted in a housing 202 on the chassis 21 of the carriage 2. A locking mechanism is provided for locking the conveyor arrangement 3 in a fixed position relative to the chassis of the carriage 2. The locking mechanism is releasable manually and the conveyor arrangement 3 can rotate freely under manual pressure such as the operator 4 pushing the conveyor arrangement when the locking mechanism is released. The locking mechanism is capable of locking the conveyor arrangement 3 in a number of angular positions relative to the carriage 2.

The wheel arrangement 19 comprises a pair of loading wheels 42 separately mounted on a pair of loading wheel axles 41 carried on a pair of wheel mounting assemblies 43. The wheel mounting assemblies 43 are connected to the chassis 21 at mutually opposing locations at or about the end of the chassis 21 carrying the operator platform 23. The wheel arrangement 19 also has a towing turntable 44 mounted on the towing end of the chassis 21 having a towing axle 46 mounted on its underside and the towing axle 46 extending from diametrically opposed locations of the towing turntable 44. Each end of the towing axle 46 has a towing wheel 47 mounted thereon. A tow bar 49 extends from and is coupled to the towing turntable 44 and protrudes beyond the towing end of the chassis 21. The tow bar 49 is pivotally coupled to the towing turntable 44.

The tow bar 49 has a first substantially horizontal position, see FIGS. 2 and 7 and a second substantially vertical position, see FIGS. 1, 3, 5 and 6 and is manually adjustable between the two positions. The towing turntable 44 is rotatably mounted on the chasis 21 and the towing axle 46 is fixedly mounted to the underside of the towing turntable 44. Therefore, the towing turntable 44 and the towing axle 46 rotate simultaneously.

Advantageously, the towing vehicle, not shown is coupled to the vehicle 1 via the tow bar 49. As the towing vehicle travels around a corner the tow bar 49 applies a torque to the towing turntable 44 causing the towing turntable 44 to rotate relative to the chassis 21. Simultaneously, the towing axle 46 rotates by the same angle causing the towed vehicle 1 to follow the direction of the towing vehicle. A towing turntable fixing mechanism is provided intermediate the towing turntable 44 and the chassis 21 and the towing turntable fixing mechanism is operable by moving the tow bar 49 between its first substantially horizontal position and its second substantially vertical position. The towing turntable fixing mechanism fixes the towing turntable 44 relative to the chassis 21 when the operator 4 moves the tow bar 49 between its first substantially horizontal position and its second substantially vertical position and releases the towing turntable 44 relative to the chassis 21 when the operator 4 moves the tow bar 49 between its second substantially vertical position and its first substantially horizontal position.

A steering arrangement, see FIG. 4 is indicated generally by the reference numeral 51 is operably coupled to the loading wheels 42 and the steering arrangement 51 is hydraulically operated by a single hydraulic ram 53 acting on a steering rod 54 coupled between the loading wheels 42.

One loading wheel 42 has a drive mechanism powered by a hydraulic motor 56. A combination control unit 211 is provided on the chassis 21 for simultaneously controlling operation of the hydraulic ram 53 of the steering arrangement 51 and the hydraulic motor 56 of the wheel drive mechanism 55. The combination control unit 211 is a joystick and box unit.

Advantageously, the control unit 211 allows a single operator 4 to deliver the vehicle 1 accurately into position at the side of the aeroplane by allowing the operator 4 to move the vehicle 1 backwards and forwards while simultaneously steering the vehicle 1.

Advantageously, when the tow bar 49 is in its first substantially horizontal position, the vehicle 1 is towable and the towing turntable 44 and towing axle 46 provide steering assistance to the operator 4 of the towing vehicle. When the towing vehicle has delivered the vehicle 1 to the site for loading and unloading, an operator 4 can raise the tow bar 49 into its second substantially vertical position which fixes the towing turntable 44 and towing axle 46 relative to the chassis 21 so that the longitudinal axis of the towing axle 46 is perpendicular to the longitudinal axis of the chassis 21. At this point, the operator 4 can operate the combination control unit to accurately locate the vehicle 1 adjacent the loading/unloading area without any further assistance from the towing vehicle.

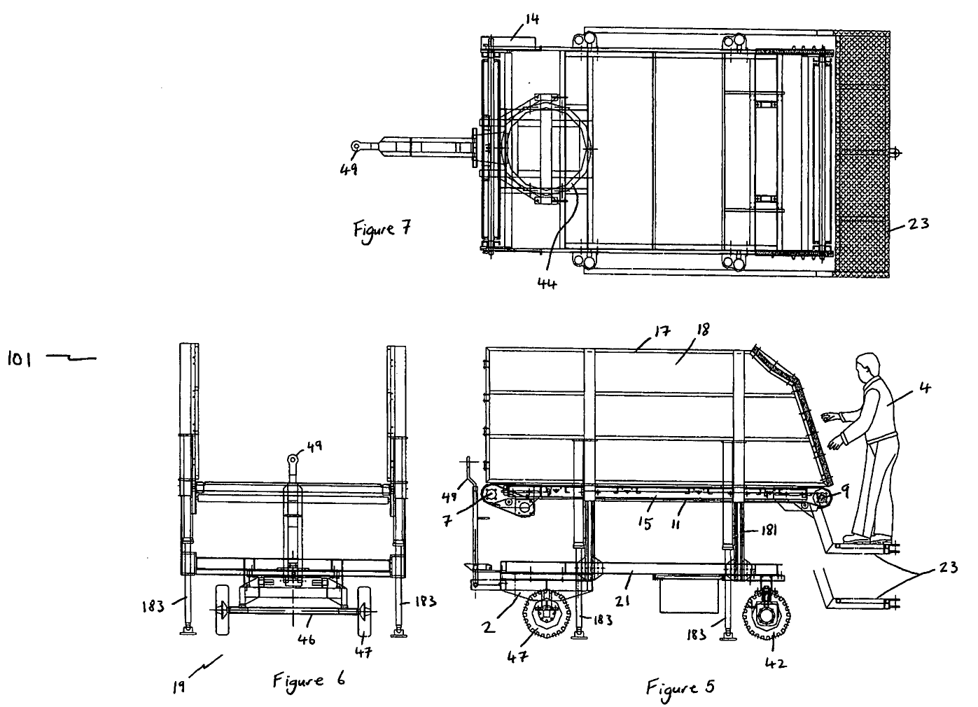

In a second embodiment of vehicle 101 shown in FIGS. 5 to 7 of the drawings, the same reference numerals have been used to reference features similar to those of FIGS. 1 to 4 and the conveyor arrangement 3 is vertically movable relative to the carriage 2. Hydraulic rams 181 are mounted intermediate the conveyor arrangement 3 and the carriage 2. Two pairs of hydraulic rams 181 are mounted on longitudinally spaced apart and mutually opposing locations along opposite lateral edges of the conveyor arrangement 3 and the carriage 2. Stabilising members are mounted on the vehicle 101 and the stabilising members are provided by hydraulically actuated stabilising jacks 183 mounted between the conveyor arrangement 3 and the ground in use. Two pairs of stabilising jacks 183 are mounted on longitudinally spaced apart and mutually opposing locations along opposite lateral edges of the conveyor arrangement 3 and the carriage 2. A separate hydraulic control unit is provided for the stabilising members.

In a third embodiment (not shown), stabilising members are coupled to a vertically adjustable bed which houses a turntable. The conveyor arrangement is rotatably mounted onto the vertically adjustable bed via the turntable. In this embodiment, the vehicle has the functionality of the vertical adjustment in combination with the rotation of the conveyor arrangement relative to the carriage.

Variations and modifications can be made without departing from the scope of the invention defined in the appended claims.

1. A vehicle comprising carriage means for transporting the vehicle along the ground and conveyor means mounted on the carriage means for conveying at least one article along the conveyor means.

2. A vehicle as claimed in claim 1, wherein the conveyor means is movably mounted on the carriage means.

3. A vehicle as claimed in claim 1, wherein the conveyor means is rotatably mounted on the carriage means.

4. A vehicle as claimed in claim 1, wherein the conveyor means is mounted on a turntable which is rotatably housed on the carriage means.

5. A vehicle as claimed in claim 1, wherein the conveyor means comprises a driver roller at one end of the conveyor means and a driven roller at the other end of the conveyor means and an endless conveyor belt wound around the driver roller and the driven roller.

6. A vehicle as claimed in claim 5, wherein conveyor drive means are in operable engagement with the driver roller.

7. A vehicle as claimed in claim 1, wherein the carriage means comprises a chassis carried on wheel means.

8. A vehicle as claimed in claim 7, wherein the chassis has an operator platform.

9. A vehicle as claimed in claim 8, wherein the operator platform is below the upper surface of the conveyor belt.

10. A vehicle as claimed in claim 8, wherein control means for the conveyor drive means are provided proximal to the operator platform.

11. A vehicle as claimed in claim 10, wherein the conveyor drive means drives the conveyor belt in a clockwise and an anticlockwise direction in response to actuation of the control means.

12. A vehicle as claimed in claim 8, wherein the wheel means comprises a pair of loading wheels mounted at mutually opposing locations at or about the end of the chassis carrying the operator platform and a pair of towing wheels mounted at mutually opposing locations at or about a towing end of the chassis.

13. A vehicle as claimed in claim 12, wherein the pair of loading wheels are separately mounted on a pair of loading wheel axles carried on a pair of wheel mounting assemblies.

14. A vehicle as claimed in claim 12, wherein the wheel means comprises a towing turntable movably mounted on the towing end of the chassis and having a towing axle mounted thereon, each end of the towing axle having a towing wheel mounted thereon.

15. A vehicle as claimed in claim 14, wherein a tow bar extends from the towing turntable and protrudes beyond the towing end of the chassis.

16. A vehicle as claimed in claim 15, wherein the tow bar has a first substantially horizontal position and a second substantially vertical position and is adjustable between the two positions for alternately fixing and releasing the towing turntable relative to the chassis.

17. A vehicle as claimed in claim 12, wherein a steering control means is operably coupled between a pair of wheels.

18. A vehicle as claimed in claim 12, wherein at least one wheel has drive means.

19. A vehicle as claimed in claim 17, wherein a means for simultaneously controlling the wheel drive means and the steering control means is provided on the vehicle.

20. A vehicle as claimed in claim 1, wherein the conveyor means is vertically movable relative to the carriage means.

21. A vehicle as claimed in claim 1, wherein the vehicle is a baggage handling apparatus.

22. A vehicle as claimed in claim 2, wherein the conveyor means is rotatably mounted on the carriage means.

23. A vehicle as claimed in claim 9, wherein control means for the conveyor drive means are provided proximal to the operator platform.

24. A vehicle as claimed in claim 13, wherein the wheel means comprises a towing turntable movably mounted on the towing end of the chassis and having a towing axle mounted thereon, each end of the towing axle having a towing wheel mounted thereon.

25. A vehicle as claimed in claim 18, wherein a means for simultaneously controlling the wheel drive means and the steering control means is provided on the vehicle.
